(19) United States
(12) Patent Application Publication
(10) Pub. No.: US 2007/0034676 A1
(43) Pub. Date: Feb. 15, 2007

(54) ELECTRIC FIELD ASSISTED SOLDER BONDING

(75) Inventors: Chunbo Zhang, Plymouth, MN (US); Robert E. Higashi, Shorewood, MN (US); Son Thai Lu, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/161,670

(22) Filed: Aug. 11, 2005

(51) Int. Cl. B23K 35/12; B23K 31/02

(52) U.S. Cl. 228/258; 228/121; 228/124.5

(57) ABSTRACT

Substrates such as wafers often have surface or other imperfections that can create gaps when the wafers are solder bonded together. Such substrates can be more effectively bonded together by subjecting an intervening solder layer to an electrostatic force that causes the solder layer to be pulled to fill at least some of any gaps that may exist between the substrates. When the solder cools, an improved solder bond is formed.

### TECHNICAL FIELD

The invention relates generally to devices including two or more substrates joined together, and relates more particularly to devices including two or more substrates that are joined together via solder bonding.

### BACKGROUND

A wide variety of devices such as electronic devices include two or more substrates such as wafers that are joined together. Indeed, wafer-to-wafer bonding can be considered to be quite important in the mass production of many micro devices that includes multiple substrates that must be bonded together. In many cases, micro devices suffer from low yield as a result of failures caused by the bonding process. Inadequate surface preparation of the substrates can cause bond failure, as current bonding techniques are quite sensitive to gaps between adjacent bonding surfaces. In some instances, only a small gap is necessary to effectively destroy the proper functioning of a micro device, particularly when the micro device relies on a bond that creates a seal such as a vacuum seal.

Solder bonding has been proposed as a solution to gaps between wafers to be joined. However, limits imposed by solder thickness and substrate condition have thus far limited repeatable, high-yield solder bonding processes. Thus, a need remains for improved techniques for joining substrates such as wafers that may have surface or other imperfections.

### SUMMARY

The present invention relates to improved techniques for joining substrates such as wafers or die that may have surface or other imperfections. More particularly, the present invention relates to improved solder bonding techniques that use an electrostatic force to help draw molten solder to fill any gaps between two substrates during the bonding process.

In one illustrative embodiment, a first substrate is solder bonded to a second substrate. The second substrate is disposed over the first substrate and a solder layer is provided between the first substrate and the second substrate. The solder layer is subjected to heat, and an electrostatic force that helps draw the molten solder to fill the space between the first substrate and the second substrate. When the solder is allowed to cool, an improved bond is formed between the first substrate and the second substrate.

In some embodiments, both the first substrate and the second substrate are at least partially conductive. The solder layer, which is also conductive, may be electrically coupled to, for example, the first substrate. A dielectric layer may be provided between the solder layer and the second substrate. A voltage may then be applied between the first substrate/solder layer and the second substrate. Heat is also applied to the solder layer, so that the solder layer enters a molten state. The voltage creates an electrostatic force between the solder layer and the second substrate which helps draw the solder layer to fill the gaps between the first substrate and the second substrate. When the solder is allowed to cool, an improved bond is formed between the first substrate and the second substrate.

In some embodiments, one or both of the first substrate and second substrate are not conductive. For example, and in one illustrative embodiment, the first substrate and the second substrate are both substantially non-conductive (e.g. glass). In some embodiments, the solder layer may be bonded to the first substrate, and a conductive layer may be provided on the second substrate. A dielectric layer may be provided over the conductive layer, if desired.

A voltage is then applied between the conductive solder layer (e.g. via an electrically connection to the solder layer) and the conductive layer on the second substrate. The voltage creates an electrostatic force between the solder layer and the patterned conductive layer on the second substrate, which helps draw the solder to fill the gaps between the first substrate and the second substrate. When the solder is allowed to cool, an improved bond is formed between the first substrate and the second substrate.

In some cases, a conductive layer may also be provided on the non-conductive first substrate. The conductive layer may make electrical contact with the solder layer by direct contact. A voltage may then be applied between the conductive layer on the first substrate (and thus the solder layer) and the conductive layer on the second substrate. The voltage creates an electrostatic force between the solder layer and the conductive layer on the second substrate that helps draw the solder, when in a heated molten state, to fill the gaps between the first substrate and the second substrate. When the solder is allowed to cool, an improved bond is formed between the first substrate and the second substrate.

In some cases, the first substrate may be conductive, partially conductive, or has a conductive layer, and the second substrate may be non-conductive. One illustrative example of this would be when the first substrate is silicon and the second substrate is glass (e.g. Pyrex™). In some embodiments, a conductive layer may be provided on the second substrate, followed by a dielectric layer. A voltage may then be applied between the conductive first substrate (and thus the solder layer) and the conductive layer on the second substrate. The voltage creates an electrostatic force between the solder layer and the conductive layer on the second substrate that helps draw the solder, when in a heated molten state, to fill the gaps between the first substrate and the second substrate. When the solder is allowed to cool, an improved bond is formed.

In another illustrative embodiment, the first substrate may be conductive, partially conductive, or has a conductive layer, and the second substrate may be non-conductive. One illustrative example of this would be when the first substrate is silicon and the second substrate is glass (e.g. Pyrex™). The solder layer is applied to the first substrate. A relatively large voltage may then be applied across the second substrate, where a first electrode is the first substrate and a second electrode is attached or positioned close to the back side of the second substrate. The voltage creates an electrostatic force between the solder layer and the second electrode that helps draw the solder, when in a heated molten state, to fill the gaps between the first substrate and the second substrate. When the solder is allowed to cool, an improved bond is formed. It is contemplated that numerous other variations of conductive and non-conductive substrates may be used, as desired.

Some substrates are non-conductive at room (or other) temperature but can become conductive or partially conductive at higher temperatures, such as Pyrex glass and some high-band-gap materials at low doping concentration such as silicon carbide (SiC) and gallium nitride (GaN). These kinds of substrates can be used as the conductive or partially conductive substrates by raising the substrate temperature during the bonding process.

The above summary of the present invention is not intended to describe each disclosed embodiment or every implementation of the present invention. The Figures, Detailed Description and Examples which follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a schematic illustration of solder bonding two substrates having a through gap between the two substrates in accordance with an embodiment of the invention;

FIG. 2 is a schematic illustration of an assembly formed from the two substrates of FIG. 1, after solder bonding;

FIG. 3 is a schematic illustration of solder bonding two substrates having an edge gap between the two substrates in accordance with an embodiment of the invention;

FIG. 4 is a schematic illustration of an assembly formed from the two substrates of FIG. 3, after solder bonding;

FIG. 5 is a schematic illustration of solder bonding two substrates having a vacuum gap between the two substrates in accordance with an embodiment of the invention;

FIG. 6 is a schematic illustration of an assembly formed from the two substrates of FIG. 5, after solder bonding;

FIG. 7 is a schematic illustration of solder bonding two substrates having a gas bubble between the two substrates in accordance with an embodiment of the invention;

FIG. 8 is a schematic illustration of an assembly formed from the two substrates of FIG. 7, after solder bonding;

FIG. 9 is a schematic illustration of solder bonding two substrates and a dielectric layer having a through gap between the one of the substrates and the dielectric layer in accordance with an embodiment of the invention;

FIG. 10 is a schematic illustration of an assembly formed from the two substrates and dielectric layer of FIG. 9, after solder bonding;

FIG. 11 is a schematic illustration of solder bonding two substrates and a dielectric layer having an edge gap between one of the substrates and the dielectric layer in accordance with an embodiment of the invention;

FIG. 12 is a schematic illustration of an assembly formed from the two substrates and dielectric layer of FIG. 11, after solder bonding; and

FIG. 13 is an exploded perspective view of an assembly including a first substrate, a second substrate, a dielectric layer and a solder ring in accordance with an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

The present invention relates generally to methods of bonding two substrates together. In particular embodiments, the present invention relates to solder bonding two substrates together using an electrostatic force assist to help draw the molten solder and fill any gaps that may exist between the two substrates to produce an improved bond.

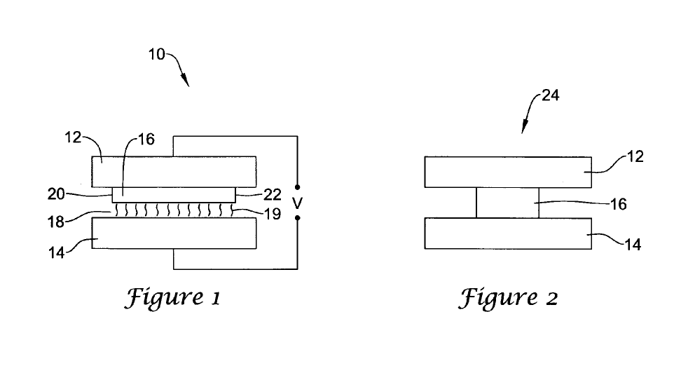

FIGS. 1 through 8 show a variety of illustrative scenarios that may be addressed by the solder bonding methods of the present invention. FIG. 1 shows an assembly 10 that includes a first substrate 12, a second substrate 14, and a solder layer 16 that is disposed between first substrate 12 and second substrate 14. First substrate 12 can be a wafer or other structure or first substrate 12 can be considered as representing a portion of a larger device. Similarly, second substrate 14 can be a wafer or other structure or second substrate 14 can be considered as representing a portion of a larger device.

In the embodiments illustrated in FIGS. 1 through 8, the first substrate 12 and second substrate 14 may each be conductive, non-conductive or semi-conductive, as desired. Solder layer 16 can be formed of any suitable solder material. Solder layer 16 can include or be formed from traditional solder materials such as lead/tin alloys. In some instances, solder layer 16 can include or be formed from any suitable solder material such as indium, silver, copper, aluminum, tin, bismuth, gallium, alloys and multi-metal layers thereof, silver coated copper, silver coated aluminum, or any other suitable solder material, as desired. In some instances, it can be useful for solder layer 16 to be formed of a solder material that has a melting point that is less than about 250 degrees C., but this is not required in all embodiments.

In the illustrated embodiment, a gap 18 initially exists between solder layer 16 and second substrate 14, at least in some region(s). In this, it should be noted that connotations of first and second substrate are arbitrary. For example, it is contemplated that gap 18 could instead exist between solder layer 16 and first substrate 12. Alternatively, , and in some cases, a second gap (not illustrated) could exist between solder layer 16 and first substrate 12 while gap 18 (as illustrated) exists between second substrate 14 and solder layer 16. As illustrated in FIG. 1, gap 18 is a through-gap, i.e. the gap extends from a first side 20 of solder layer 16 to a second side 22 of solder layer 16. Gap 18 can result from, for example, manufacturing tolerances in the production of first substrate 12, second substrate 14 and/or solder layer 16, surface imperfections, and/or wafer bowing.

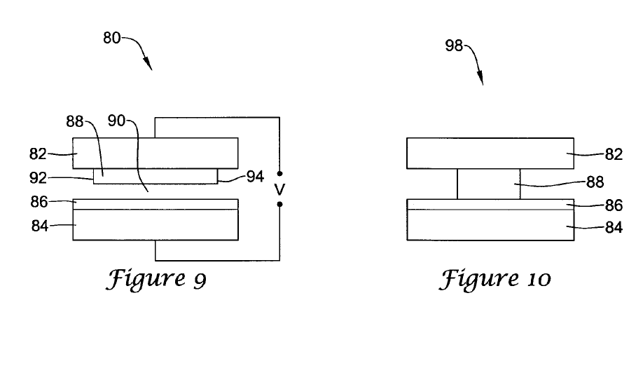

In some embodiments, one or both of the first substrate 12 and the second substrate 14 are at least partially conductive, but this is not required in all embodiments. The solder layer 16, which is conductive, may be electrically coupled to, for example, the first substrate 12 when the first substrate is conductive. A dielectric layer (see, for example, FIGS. 9-13) may be provided between the solder layer 16 and the second substrate 14, when the second substrate is conductive.

A voltage “V” may be applied between the first substrate/solder layer, which are electrically coupled together in some embodiments, and the second substrate 14. In some embodiments, it can be useful to provide a voltage of about 10 to about 100 volts, but other voltages may be used, depending on the application. Heat is also applied to the solder layer 16, so that the solder layer enters a molten state. The voltage V creates an electrostatic force 19 between the solder layer 16 and the second substrate 14 which helps draw the solder layer 16 to fill the gaps between the first substrate 12 and the second substrate 14, as shown in FIG. 2. When the solder layer 16 is allowed to cool with the electrostatic force applied, an improved bond is formed between the first substrate 12 and the second substrate 14.

In some cases, one or both of the first substrate 12 and second substrate 14 need not be conductive. For example, and in one illustrative embodiment, the first substrate 12 and the second substrate 14 may both be substantially non-conductive (e.g. glass). In some embodiments, the solder layer 16 may be bonded to the first substrate 12, and a conductive layer (see, for example, FIGS. 11-12) may be provided on the second substrate 14. A dielectric layer (see, for example, FIGS. 11-12) may be provided over the conductive layer.

A voltage V may then be applied between the conductive solder layer 16 and the conductive layer on the second substrate 14. The voltage creates an electrostatic force 19 between the solder layer 16 and the conductive layer on the second substrate 14, which helps draw the solder to fill the gaps between the first substrate 12 and the second substrate 14, as shown in FIG. 2. When the solder 16 is allowed to cool, an improved bond is formed between the first substrate 12 and the second substrate 14.

A conductive layer (not explicitly shown) may also be patterned on a non-conductive first substrate 12. The conductive layer may make electrical contact with the solder layer 16 during the bonding process. A voltage V may then be applied between the conductive layer on the non-conductive first substrate 12 (and thus the solder layer 16) and the conductive layer on the non-conductive second substrate 14. The voltage V creates an electrostatic force 19 between the solder layer 16 and the conductive layer on the second substrate 14 that helps draw the solder 16, when in a heated molten state, to fill the gaps 18 between the first substrate 12 and the second substrate 14, as shown in FIG. 2. When the solder is allowed to cool, an improved bond is formed between the first substrate 12 and the second substrate 14.

In some embodiments, the first substrate 12 may be conductive and the second substrate 14 may be non-conductive. One illustrative example of this would be when the first substrate 12 is silicon and the second substrate 14 is glass (e.g. Pyrex™). A conductive layer (see, for example, FIGS. 11-12) may be provided on the second substrate 14, followed by a dielectric layer (see, for example, FIGS. 11-12). A voltage V may then be applied between the first substrate 12 (and thus the solder layer 16) and the conductive layer on the second substrate 14. The voltage creates an electrostatic force 19 between the solder layer 16 and the conductive layer on the second substrate 14 that helps draw the solder 16, when in a heated molten state, to fill the gaps 18 between the first substrate 12 and the second substrate 14. When the solder is allowed to cool, an improved bond is formed between the first substrate 12 and the second substrate 14.

In another illustrative embodiment, the first substrate 12 may be conductive, partially conductive, or has a conductive layer, and the second substrate 14 may be non-conductive. One illustrative example of this would be when the first substrate 12 is silicon and the second substrate 14 is glass (e.g. Pyrex™). A solder layer 16 may be applied to the first substrate 12. A relatively large voltage may then be applied across the second substrate 14, where a first electrode is the first substrate 12 and a second electrode is attached or positioned close to the back side of the second substrate 14. The voltage creates an electrostatic force between the solder layer 16 and the second electrode that helps draw the solder 16, when in a heated molten state, to fill the gaps between the first substrate 12 and the second substrate 14. When the solder 16 is allowed to cool, an improved bond is formed. It is contemplated that numerous other variations of conductive and non-conductive substrates may be used, as desired.

Some substrates are non-conductive at room (or other) temperature but can become conductive or partially conductive at higher temperatures, such as Pyrex glass and some high-band-gap materials at low doping concentration such as silicon carbide (SiC) and gallium nitride (GaN). These kinds of substrates can be used as the conductive or partially conductive substrates by raising the substrate temperature during the bonding process.

FIG. 2 illustrates an assembly 24 that includes first substrate 12, second substrate 14 and a solder layer 16 disposed therebetween. While a distance between first substrate 12 and second substrate 14 is at least substantially unchanged with respect to FIG. 1, it can be seen that there is no longer a gap 18 between the solder layer 16 and the second substrate 14. While the volume of solder layer 16 is at least substantially unchanged with respect to that illustrated in FIG. 1, it can be seen that the solder material 16 has been drawn towards and is now in contact with second substrate 14. It can be said that solder layer 16 is now thicker but narrower than the solder layer 16 shown in FIG. 1, at least in the region of the gap 18.

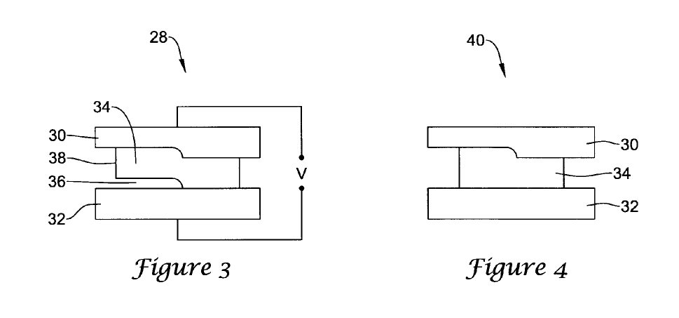

FIG. 3 illustrates an assembly 28 that includes a first substrate 30, a second substrate 32 and a solder layer 34 disposed between first substrate 30 and second substrate 32. A gap 36 exists between at a portion of solder layer 34 and second substrate 32. In the illustrated embodiment, gap 36 is an edge gap that starts at an end 38 of solder layer 34 and extends at least partially inwardly therefrom. First substrate 30, second substrate 32 and solder layer 34 can be formed from any suitable materials as discussed with respect to the elements of FIG. 1. In some embodiments, gap 36 is formed by manufacturing tolerances or other defects in (as illustrated) the first substrate 30.

As discussed with respect to FIGS. 1 and 2, a potential difference or voltage V can be applied between solder layer 34 and the second substrate 32. Voltage V can be applied using any suitable technique and at any suitable potential difference. As a result of applying a voltage V between solder layer 34 and the second substrate 32, and with respect to the illustrated configuration, solder layer 34 may move towards second substrate 14 as shown. As noted, sufficient heat can be applied to solder layer 34 such that solder layer 34 is molten and thus can more easily move in response to applied electromagnetic fields.

FIG. 4 illustrates an assembly 40 that includes the first substrate 30, the second substrate 32 and solder layer 34 disposed therebetween. While a distance between first substrate 30 and second substrate 32 is at least substantially unchanged with respect to FIG. 3, it can be seen that there is no longer a gap 36 between the solder layer 34 and the second substrate 32. While the volume of solder layer 34 is at least substantially unchanged with respect to that illustrated in FIG. 3, it can be seen that the solder material has been drawn towards and is now in contact with second substrate 32.

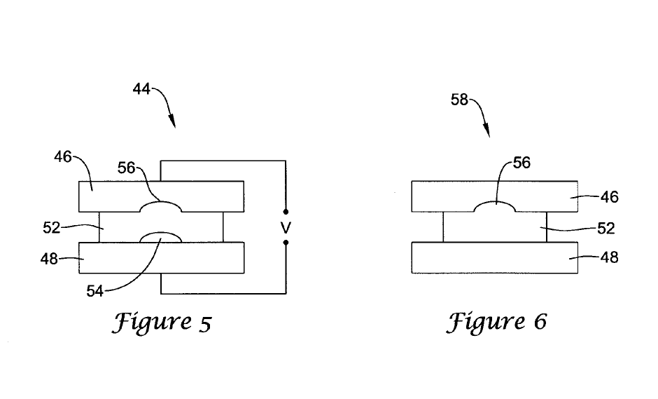

FIG. 5 shows an assembly 44 that includes a first substrate 46, a second hsubstrate 48 and a solder layer 52 disposed between first substrate 46 and second substrate 48. In the illustrative embodiment, a vacuum gap or bubble 54 has formed in solder layer 52 adjacent or near to second substrate 48. Vacuum gap 54 may form for a variety of reasons, but in the illustrated embodiment, a gap or imperfection 56 in first substrate 46 has created vacuum gap 54. First substrate 46, second substrate 48 and solder layer 52 can be formed of any suitable materials as discussed previously with respect to FIGS. 1 and 2.

A potential difference or voltage V can be applied between solder layer 52 and the second substrate 48. Voltage V can be applied using any suitable technique and at any suitable potential difference. As a result of applying voltage V between solder layer 52 and the second substrate 48, and with respect to the illustrated configuration, molten solder layer 52 may move towards second substrate 48 in response to an electrostatic force generated by the potential difference V.

FIG. 6 illustrates an assembly 58 that includes first substrate 46, second substrate 48 and solder layer 52 disposed therebetween. While a distance between first substrate 46 and second substrate 48 is at least substantially unchanged with respect to FIG. 5, it can be seen that there is no longer a vacuum gap 54 (FIG. 5) between the solder layer 52 and the second substrate 48. While the volume of solder layer 52 is at least substantially unchanged with respect to that illustrated in FIG. 5, it can be seen that the solder material has been drawn towards and is now in contact with second substrate 48.

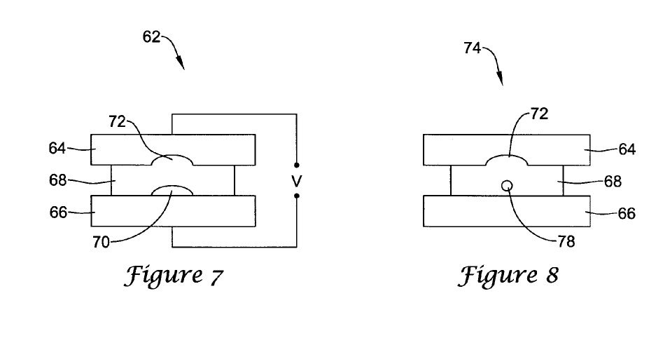

FIG. 7 illustrates an assembly 62 that includes a first substrate 64, a second substrate 66 and a solder layer 68 that is disposed between first substrate 64 and second substrate 66. In some instances, a gas gap 70 may form in solder layer 68 near second substrate 66. In some instances, formation of gas gap 70 may be caused at least in part by an imperfection 72 in first substrate 54. First substrate 64, second substrate 66 and solder layer 68 can be formed of any suitable materials as discussed previously with respect to FIGS. 1 and 2.

As discussed above, a potential difference or voltage V can be applied between solder layer 68 and the second substrate 66. Voltage V can be applied using any suitable technique and at any suitable potential difference. As a result of applying voltage V between solder layer 68 and the second substrate 66, and with respect to the illustrated configuration, molten solder layer 68 may move towards second substrate 66.

FIG. 8 illustrates an assembly 74 that includes the first substrate 64, the second substrate 66 and the solder layer 68 disposed therebetween. While a distance between first substrate 64 and second substrate 66 is at least substantially unchanged with respect to FIG. 7, it can be seen that gas gap 70 (FIG. 7) has now formed a gas bubble 78 that is either no longer in contact with second substrate 66 or only in point contact with second substrate 66 as a result of preferably molten solder layer 68 moving towards second substrate 66 in response to the applied electrostatic force. While a gas bubble 78 may remain, it is positioned such that it does not materially impact the strength of the solder bond between the first substrate 64 and second substrate 66.

FIGS. 9 through 12 show a variety of illustrative scenarios that may be addressed by the solder bonding methods in accordance with the present invention. FIG. 9 shows an assembly 80 that includes a first substrate 82, a second substrate 84, a dielectric layer 86 disposed adjacent the second substrate 84, and a solder layer 88 that is disposed between first substrate 82 and dielectric layer 86. In this illustrative embodiment, both the first substrate 82 and the second substrate 84 may be at least partially conductive.

First substrate 82 can be a wafer or other structure or first substrate 82 can be considered as representing a portion of a larger device. Similarly, second substrate 84 can be a wafer or other structure or second substrate 84 can be considered as representing a portion of a larger device. Dielectric layer 86 may be formed of any suitable dielectric material. Examples of suitable dielectric materials include, for example, organic materials such as parylene, acrylates and polyimides and inorganic materials such as nitrides and oxides. Particular inorganic dielectric materials include silicon dioxide and silicon nitride. However, other dielectric materials may be used.

In some instances, it can be useful to select the specific solder material for forming solder layer 88 and the dielectric material for forming dielectric layer 86 in combination such that solder layer 88 can, once molten, adequately wet and bond to dielectric layer 86. In some embodiments, it may be useful to add an alloying element to the material used to form solder layer 88. For example, aluminum can be added to tin to reduce the contact angle and hence improve wet ability. In some embodiments, it can be useful to increase the dissolved oxygen content and thus increase ionic interactions between the solder metal and the oxides in the dielectric. The dissolved oxygen content in the dielectric layer 86 may be increased by, for example, increasing the partial pressure of oxygen under which dielectric layer 86 is formed.

In a particular example, a surface-active agent such as titanium or zirconium may be added to the solder material in forming solder layer 88. It is believed that strong interactions between the added metals and the dielectric material (such as an oxide) lower the surface energy of the solder melt. As a result, the solder may more readily wet with the dielectric material. In another example, solder layer 88 may include or be formed from a solder material containing indium, and the dielectric layer 86 may be phosphorus-rich. It is believed that some phosphorus and indium will react to form InP in the boding interface, which may improve the bonding between the solder and dielectric.

In the illustrated embodiment, a gap 90 exists between solder layer 88 and dielectric layer 86. In this, it should be noted that connotations of first and second substrate are arbitrary. For example, it is contemplated that gap 90 could instead exist between solder layer 88 and first substrate 82. Alternatively, and in some cases, a second gap (not illustrated) could exist between solder layer 88 and first substrate 82 while gap 90 (as illustrated) exists between dielectric layer 86 and solder layer 88. As illustrated, gap 90 is a through-gap, i.e. the gap extends from a first side 90 of solder layer 88 to a second side 92 of solder layer 88. Gap 90 can result from manufacturing tolerances or other material defects.

In a particular assembly method, a potential difference or voltage V can be applied between first substrate 82 and thus the solder layer 88, and the second substrate 84. Voltage V can be applied using any suitable technique and at any suitable potential difference. In the illustrative embodiment, the dielectric layer may help prevent an electrical short between the solder layer 88 and the second substrate 84. The voltage applied can in some instances be a function of the particular dielectric material selected in forming dielectric layer 86. While thicker materials can sustain higher voltage, the dielectric thickness does not impact the maximum electrostatic force, as shown in the following equations:

$$F = \frac{ɛ {AV}^{2}}{2 {t}^{2}}$$

where
V_{BD}=Gt
where F is the electrostatic force, ε is the dielectric constant of the dielectric material 86, A is the overall bonding area, V is the applied voltage and t is the thickness of the dielectric material 86. The maximum electrostatic force can be found by combining the two equations, as follows:

$$F = \frac{ɛ {AG}^{2}}{2}$$

As a result of applying a voltage V between first substrate 82 and second substrate 84, and with respect to the illustrated configuration, solder layer 88 may move towards dielectric layer 86 (and thus towards second substrate 84) in response to the resulting electrostatic force. In particular embodiments, sufficient heat can be applied to solder layer 88 such that solder layer 88 is molten and thus can more easily move in response to applied electromagnetic fields.

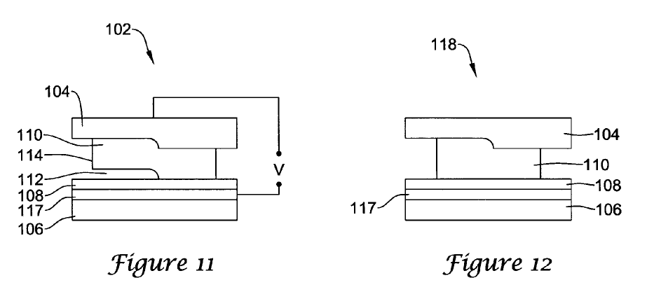

FIG. 10 illustrates an assembly 98 that includes the first substrate 82, the second substrate 84, the dielectric layer 86 and the solder layer 88 disposed therebetween. While a distance between first substrate 82 and dielectric layer 86 is at least substantially unchanged with respect to FIG. 9, it can be seen that there is no longer a gap 90 between the solder layer 88 and the dielectric layer 86. While the volume of solder layer 100 is at least substantially unchanged with respect to that illustrated in FIG. 9, it can be seen that the solder material has been drawn towards and is now in contact with dielectric layer 86. It can be said that solder layer 100 is now thicker but narrower than solder layer 88 (FIG. 9), at least in the region of the gap 90.

FIG. 11 illustrates an assembly 102 that includes a first substrate 104, a second substrate 106, a conductive layer 117 disposed adjacent or part of the second substrate 106, a dielectric layer 108 disposed adjacent the conductive layer 117, and a solder layer 110 that is disposed between first substrate 104 and dielectric layer 108. In this illustrative embodiment, the first substrate 104 may be conductive and the second substrate 106 may be substantially non-conductive.

A gap 112 exists between at a portion of solder layer 110 and the dielectric layer 108. In the illustrated embodiment, gap 112 is an edge gap that starts at an end 114 of solder layer 110 and extends at least partially inwardly therefrom, but it is contemplated that the gap may be any other type of gap, as further described above. In some embodiments, gap 112 is formed by manufacturing tolerances or other defects. Each of first substrate 104, second substrate 106, dielectric layer 108 and solder layer 110 can be formed of any suitable material such as those discussed above.

In a particular assembly method, a potential difference or voltage V can be applied between first substrate 104 and the conductive layer 117, as shown. Voltage V can be applied using any suitable technique and at any suitable potential difference as discussed previously.

FIG. 12 illustrates an assembly 118 that includes the first substrate 104, the second substrate 106, the conductive layer 117, the dielectric layer 108 and the solder layer 110 disposed therebetween. While a distance between first substrate 104 and dielectric layer 108 is at least substantially unchanged with respect to FIG. 11, it can be seen that there is no longer a gap between the solder layer 110 and the dielectric layer 108. While the volume of solder layer 110 is at least substantially unchanged with respect to that illustrated in FIG. 11, it can be seen that the solder material has been drawn towards and is now in contact with dielectric layer 108.

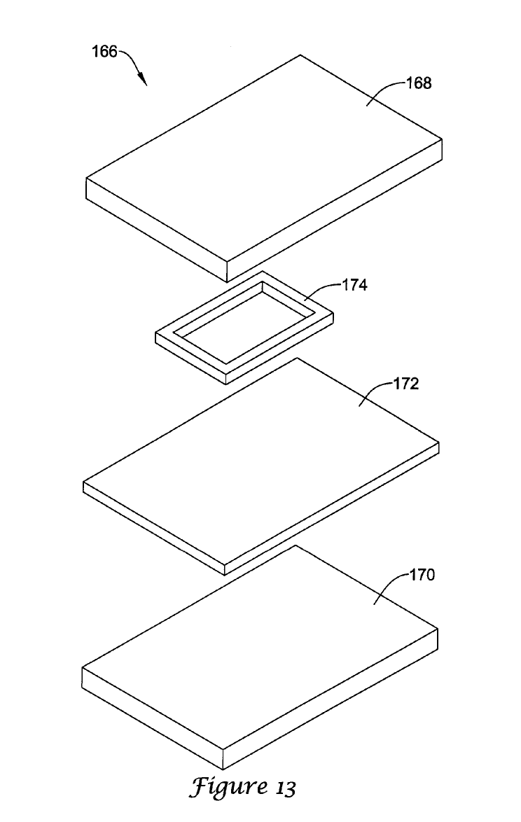

FIG. 13 is an exploded perspective view of an assembly 166 including components that may be combined in accordance with the present invention to form a vacuum cavity. FIG. 13 includes a first substrate 168, a second substrate 170, a dielectric layer 172 and a solder ring 174. It can be seen that a vacuum or gas cavity can be formed that is bounded by first substrate 168, dielectric layer 172 and solder ring 174. Each of the first substrate 168, the second substrate 170, the dielectric layer 172 and the solder ring 174 can be formed of any suitable materials as previously discussed herein.

The invention should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

What is claimed is:

1. A method of joining a first substrate and a second substrate, the method comprising the steps of:
disposing the second substrate over the first substrate;
providing a solder layer between the first substrate and the second substrate;
heating the solder layer to a molten state; and
subjecting the molten solder layer to an electrostatic force to draw the molten solder toward one or both of the first and/or second substrates.

2. The method of claim 1 further comprising the step of allowing the molten solder layer to cool to a solid state while and/or after the solder layer is subject to the electrostatic force.

3. The method of claim 1, wherein the step of subjecting the solder layer to an electrostatic force comprises providing a potential difference between the solder layer and at least one of the first substrate and the second substrate.

4. The method of claim 1, wherein the step of subjecting the solder layer to an electrostatic force causes the solder layer to be pulled to fill at least some of any gaps that may exist between the first substrate and the second substrate.

5. The method of claim 4 wherein both of the first substrate and the second substrate are at least partially conductive.

6. The method of claim 5 wherein one or both of the first substrate and second substrate include a dielectric layer situated adjacent the solder layer.

7. The method of claim 4, wherein at least one of the first substrate and the second substrate is substantially non-conductive.

8. The method of claim 7 wherein the at least one of the first substrate and the second substrate that is substantially non-conductive includes a conductive layer covered by a dielectric layer.

9. The method of claim 8, wherein the step of subjecting the solder layer to an electrostatic force step comprises providing a potential difference between the solder layer and the conductive layer.

10. The method of claim 1, wherein the first substrate comprises silicon.

11. The method of claim 1, wherein the first substrate comprises glass.

12. The method of claim 1, wherein both the first substrate and the second substrate comprise silicon.

13. The method of claim 1, wherein both the first substrate and the second substrate comprise glass.

14. A method of joining a first substrate and a second substrate, the method comprising the steps of:
providing a conductive first substrate;
providing a conductive second substrate, the second substrate having a dielectric layer provided adjacent thereto;
disposing the second substrate over the first substrate, with the dielectric layer of the second substrate facing the first substrate;
providing a solder layer between the first substrate and the second substrate;
heating the solder layer to a molten state; and
subjecting the molten solder layer to an electrostatic force to draw the molten solder toward one or both of the first and/or second substrates.

15. The method of claim 14, wherein the step of subjecting the solder layer to an electrostatic force comprises providing a potential difference between the first substrate and the second substrate.

16. The method of claim 14, wherein the step of subjecting the solder layer to an electrostatic force causes the solder layer to be pulled to fill at least some of any gaps that may exist between the first substrate and the second substrate.

17. A method of joining a first substrate and a second substrate, the first substrate having a joining surface comprising a nonlinear topography, the method comprising the steps of:
disposing the second substrate over the first substrate such that the second substrate is adjacent the joining surface of the first substrate;
providing a molten solder layer between the first substrate and the substrate; and
subjecting the solder layer to an electrostatic force.

18. The method of claim 17 further comprising the step of allowing the molten solder layer to cool to a solid state while the solder layer is subject to the electrostatic force.

19. The method of claim 17, further comprising a step of disposing a dielectric layer between the first substrate and the second substrate.

20. The method of claim 17, wherein the step of subjecting the solder layer to an electrostatic force comprises providing a potential difference between the solder layer and one of the first substrate and the second substrate.

21. A method of joining a first substrate to a second substrate, the method comprising the steps of:
providing a solder ring;
disposing the second substrate adjacent the first substrate, with the solder ring positioned therebetween;
heating the solder ring so that the solder ring enters a molten state;
subjecting the molten solder ring to an electrostatic force that causes the molten solder ring to be pulled to fill at least some of any gaps that may exist between the first substrate and the second substrate; and allowing the molten solder layer to cool to a solid state while the molten solder ring is subject to the electrostatic force.

22. The method of claim 21, wherein the heating step comprises heating the solder ring to a temperature that is less than about 250° C.

23. The method of claim 21, further comprising a step of providing a dielectric layer adjacent at least one of the first substrate or the second substrate.
